(19) United States
(12) Patent Application Publication
(10) Pub. No.: US 2004/0165068 A1
(43) Pub. Date: Aug. 26, 2004

(54) Projector color calibration device and method

(76) Inventor: Rone Fue Jane, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/372,146

(22) Filed: Feb. 25, 2003

(51) Int. Cl. H04N 17/00

(52) U.S. Cl. 348/189; 348/744

(57) ABSTRACT

A projector color calibration device and a method thereof are provided. The device is installed in a projector, and comprises a photo detection component used to receive a color brightness value, an image signal processing unit used to process an image signal inputted to the projector and to store the processed image into a memory, and a central processor used to compare the color brightness value detected by the photo detection component with the image signal inputted to the projector and to perform color calibration for obtaining an accurate color output value. It is not necessary for a user to manually adjust the output color of the projector. Moreover, the optimum automatic adjustment can be accomplished to meet the requirements in different environments.

### FIELD OF THE INVENTION

The present invention relates to a projector and, more particularly, to a device and a method capable of automatically performing color calibration.

### BACKGROUND OF THE INVENTION

For one usually making briefings, a projector is an essential tool in work. No matter for explaining to customers or for teaching, in addition to a notebook computer, a projector is inevitable to have vivid sound and light effects. Nowadays, people more and more appreciate relaxations and entertainments so that building a home theater becomes a trend. Because projectors are used as important equipments of home theaters for viewing films, the requirement of projector in the digital AV market is steadily on the increase.

For the time being, when a conventional projector leaves the factory, the outputted red, green, and blue lights are calibrated on a standard projection screen to acquire accurate output colors. After a user buys a projector, if the projector is used in an environment different from the standard projection screen, a color behavior different from that calibrated at the factory is usually obtained. The user thus needs to manually adjust the brightness values of the red, green, and blue lights of the projector. Once the projection environment changes, the user needs to manually adjust the output colors to obtain a satisfactory color behavior before making a briefing, watching a film, or proceeding other activities, hence causing much inconvenience and trouble of the user.

Accordingly, the present invention aims to propose a projector color calibration device capable of performing color calibration and a method thereof to resolve the problems in the prior art.

### SUMMARY AND OBJECTS OF THE PRESENT INVENTION

The primary object of the present invention is to propose a projector color calibration device and a method thereof, wherein a photo detection component is utilized to read brightness values of the red, green, and blue lights in different environments for color calibration so that a projector can automatically adjust the brightness values of the outputted red, green, and blue lights until the projected color is accurate.

Another object of the present invention is to propose a projector color calibration device and a method thereof, whereby a projector can match different environments to perform the optimum automatic adjustment until an accurate color output is obtained without the need of manual adjustment.

To achieve the above objects, a projector color calibration device is installed in a projector and a color calibration method is also provided. The device comprises a photo detection component, an image signal processing unit, and a central processor. The photo detection component is used to receive a color brightness value and to convert it into a proportional voltage value. An analog-to-digital converter is used to convert the voltage value into a digital signal. The image signal processing unit is used to process an image signal inputted to the projector. The image signal is converted into a digital signal by another analog-to-digital converter. The processed image signal is then stored into a memory. The central processor compares the color brightness value detected by the photo detection component with the image signal in the memory, performs color calibration to adjust the image signal, and stores a comparison value of the color brightness value detected by the photo detection component and the calibrated image signal into a comparison table.

A color calibration method of the present invention processes a color brightness value detected by a photo detection component and an output light of a projector. The color calibration method comprises the following steps. The output light of the projector is adjusted to let the read values of the red, green, and blue colors in the photo detection component are the desired set values. A comparison value of the output light of the projector with the color brightness value detected by the photo detection component is stored into a comparison table. Finally, those parts in the comparison table having no comparison values are calculated by interpolation and then filled. When a different image signal is inputted to the projector, an accurate light can be outputted to the projection environment for use according to the comparison value in the comparison table.

The various objects and advantages of the present invention will be more readily understood from the following detailed description when read in conjunction with the appended drawings, in which:

### BRIEF DESCRIPTION OF DRAWINGS

FIG. 1 is a block diagram of a projector color calibration device of the present invention; and

FIGS. 2(a) to 2 (c) are flowcharts of color calibration of the present invention.

### DETAILED DESCRIPTION OF PREFERRED EMBODIMENT

The present invention utilizes a photo detection component to read color brightness values of the red (R), green (G), and blue (B) lights at different projection environments, and makes use of a color calibration method to adjust the output color brightness of the R, G, and B lights of the projector until accurate colors are obtained.

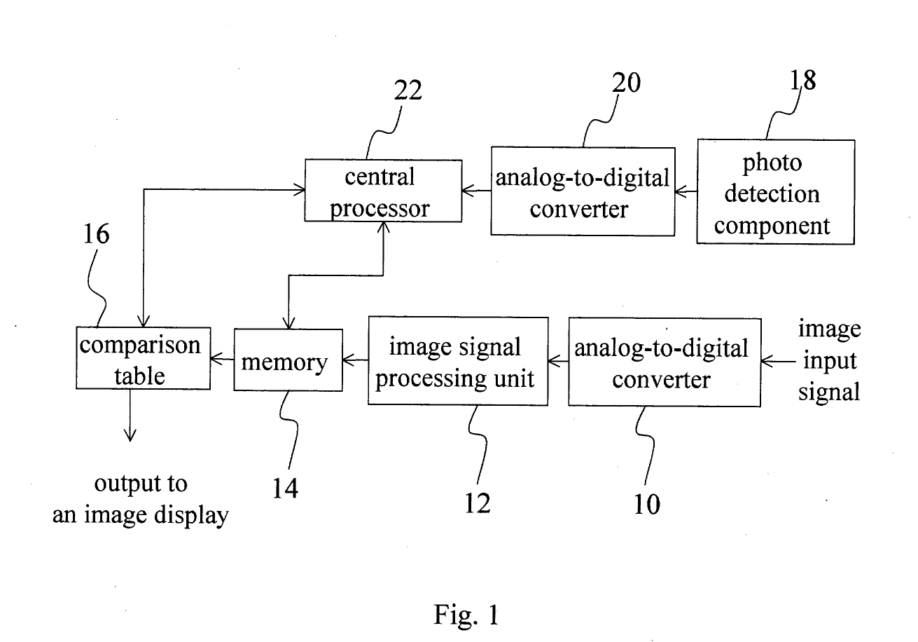

As shown in FIG. 1, a projector color calibration device is installed in a projector. The device comprises a photo detection component 18, two analog-to-digital converters 10 and 20, an image signal processing unit 12, a memory 14, and a central processor 22. The photo detection component 18 is used to detect a color brightness value and to convert it into a proportional voltage. The analog-to-digital converter 20 is used to convert the voltage into a digital signal. The analog-to-digital converter 10 converts an image signal imputed by the projector into a digital signal. The image signal processing unit 12 is used to adjust the resolution of the image signal. The adjusted image signal is then stored into the memory 14. The central processor 22 compares the color brightness value detected by the photo detection component 18 with the image signal in the memory 14, performs color calibration to calibrate the image signal, and stores a comparison value of the color brightness value detected by the photo detection component 18 and the calibrated image signal into a comparison table 16. The photo detection component 18 is a photodiode, a charge coupled device (CCD), or a complementary metal oxide semiconductor (CMOS).

When a projector inputs an image signal, the image signal is first converted into a digital signal by the analog-to-digital converter 10. The resolution of the converted image input signal is then adjusted by the image signal processing unit 12. Next, the resolution-adjusted image input signal is stored into the memory 14. Simultaneously, the photo detection component 18 is used to detect a color brightness value of the ambient environment and to convert the color brightness value into a proportional voltage. The analog-to-digital converter 20 is used to convert this voltage into a digital signal, which is then sent to the central processor 22 for decision. The central processor 22 is used to compare the color brightness value detected by the photo detection component 18 with the image signal in the memory 14 for color calibration to calibrate the image signal to obtain an accurate output color brightness value, and to store a comparison value of the color brightness value detected by the photo detection component 18 and the calibrated image signal into the comparison table 16. When a different image signal is inputted to the projector, an accurate light can be outputted to the projection environment for use according to the comparison value in the comparison table 16, hence reconstructing the accurate image colors.

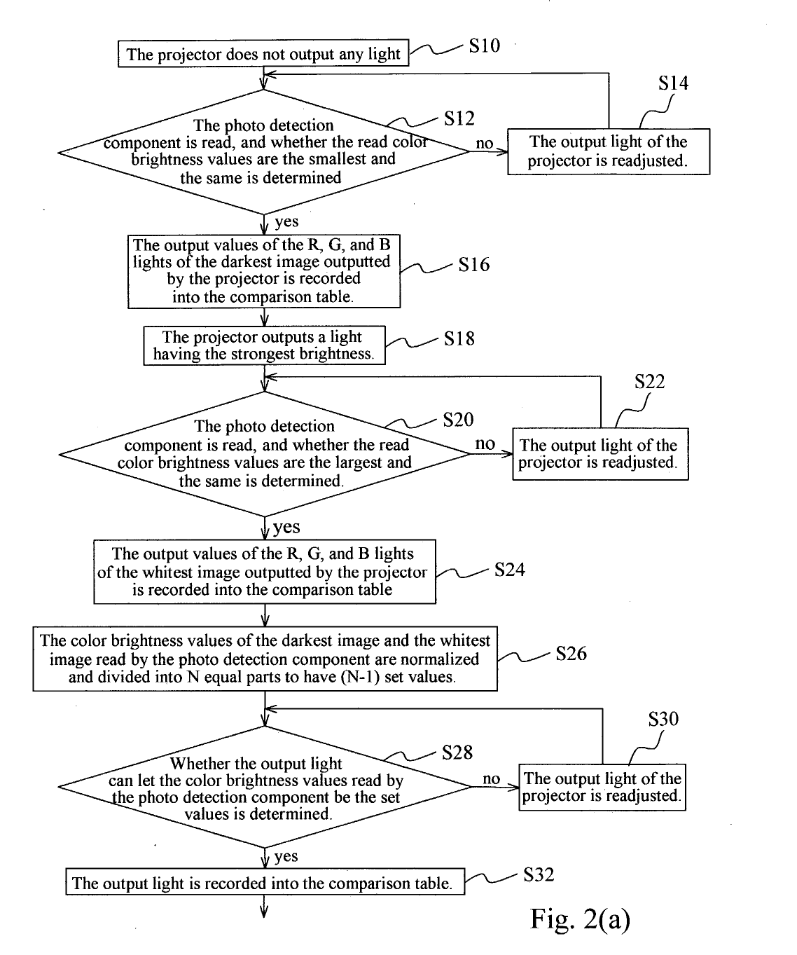

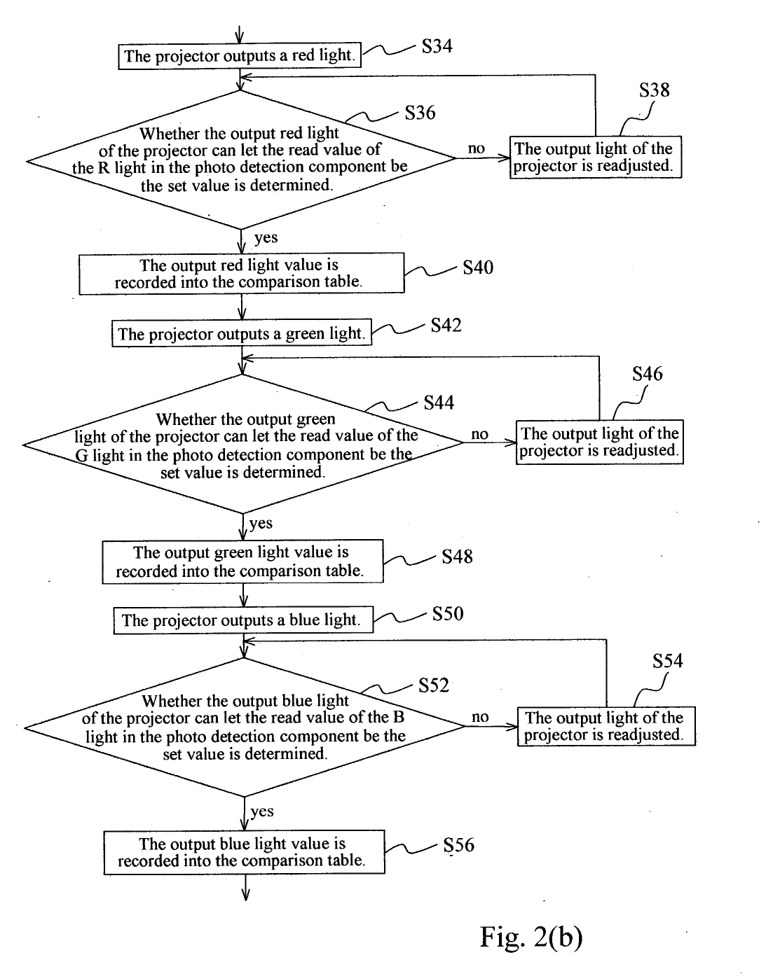

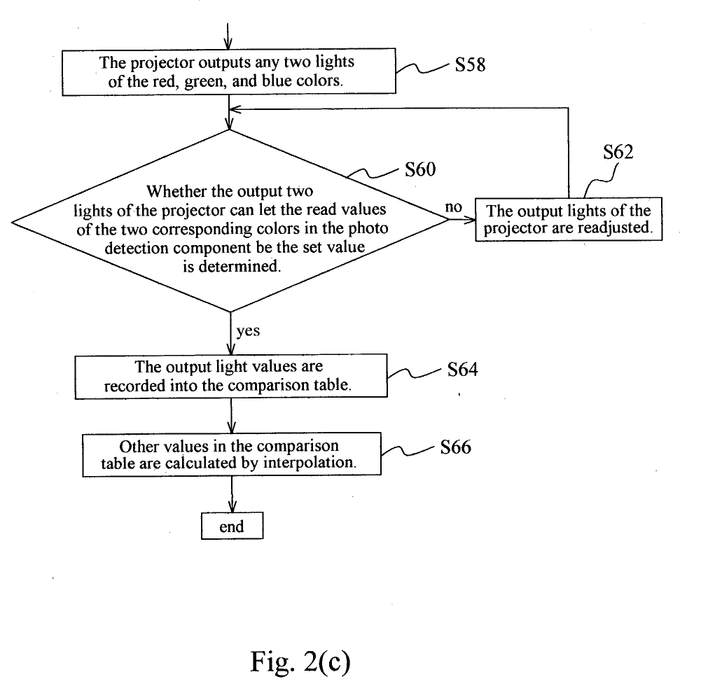

FIGS. 2(a) to 2 (c) are flowcharts of color calibration of the present invention. As shown in FIG. 2(a), first, calibration of the black color is calibrated. The projector does not output any light (Step S10). The color brightness values of the R, G, and B lights read by the photo detection component 18 at this time represent light color and brightness data of the ambient environment. Next, after the color brightness values of the R, G, and B lights in the photo detection component 18 are read, whether the read color brightness values are the smallest and the same is determined (Step S12). If the answer is negative, Step S14 is jumped to for readjusting the output light of the projector, and Step S12 is jumped back to for decision again until the read color brightness values in the photo detection component 18 are the smallest and the same. At this time, the image brightness will have an offset value but have no color offset. This image brightness is the darkest image without color offset at this environment. Step 16 can then be performed to record the output values of the R, C, and B lights of the darkest image outputted by the projector and the read values of the photo detection component 18 at this time into the comparison table 16.

Next, calibration of the white color is performed. The projector outputs a white light having equal R, G, and B color lights and the strongest brightness (Step S18). The color brightness values of the R, G, and B lights read by the photo detection component 18 at this time represent brightness data of different color lights reflected by a projection screen. Next, after the color brightness values of the R, G, and B lights in the photo detection component 18 are read, whether the read color brightness values are the largest and the same is determined (Step S20). If the answer is negative, Step S22 is jumped to for readjusting the output light of the projector, and Step S20 is jumped back to for decision again until the read color brightness values in the photo detection component 18 are the largest and the same. When the read color brightness values in the photo detection component 18 are the largest and the same, the output image of the projector at this time is the whitest image without color offset that can be projected at this environment. Step 24 can then be performed to record the output values of the R, G and B lights of the whitest image outputted by the projector and the read values of the photo detection component 18 at this time into the comparison table 16.

The above order of calibration of the darkest color and the whitest color can be exchanged arbitrarily.

After the calibration of the darkest color and the whitest color of the projector is finished, the calibration of other gray-scale lights projected by the projector is performed. The color brightness values of the R, G, and B lights read by the photo detection component 18 of the darkest image without color offset that can be projected by the projector at this environment are normalized to 0, 0, 0, the color brightness values of the R, G, and B lights read by the photo detection component 18 of the whitest image without color offset that can be projected by the projector at this environment are normalized to 255, 255, 255, and the color brightness values of the R, G, and B lights in photo detection component 18 are divided into N equal parts to have (N−1) set values spaced by 255/N, and these are recorded into the comparison table 18 (Step S26). For instance, if the color brightness values of the R, G and B lights are divided into 5 equal parts, the measurement spacing is 51, and the 4 set values of the color brightness values of the R, G, and B lights are 51, 51, 51, 102, 102, 102, 153, 153, 153, 204, 204, 204. Next, the projector outputs several gray-scale images to determine whether the color brightness values of the R, G and B lights read by the photo detection component 18 are the set values (Step 28). If the answer is negative, Step 30 is performed to readjust the output light of the projector, and Step 28 is jumped back to for decision again until the output light of the projector lets the color brightness values of the R, G, and B lights read by the photo detection component 18 are the set values. Step S32 can then be performed to record output values of the R, G, and B lights of the actual output light of the projector and the read values of the photo detection component 18 at this time into the comparison table 16. In this embodiment, 255/N is used as the gray-scale measurement spacing. In practical applications, the measurement spacing can be changed according to necessity, and the measurement spacing needs not to be equal.

Subsequently, as shown in FIG. 2(b), the calibration of the three primary colors of the R, G, ad B lights can be performed. The projector first outputs an R light (Step S34). Whether the output R light of the projector can let the read value of the R light in the photo detection component 18 be the set value in Step S26 is determined (Step S36). If the answer is negative, Step S38 is performed to readjust the output light of the projector, and Step S36 is jumped back to for decision again until the output R light of the projector lets the read value of the R light in the photo detection component 18 be the set value. Step 40 can then be performed to record the value of the actual output R light of the projector and the read value of the photo detection component 18 at this time into the comparison table 16. Next, the calibrations of the G and B lights are performed in Step 42 to Step 48 and Step 50 to Step 56, respectively. Because these steps are the same as those from S34 to S40 with only the output R light of the projector being changed to the G and B lights, they will not be further described.

Subsequently, the calibrations of the red-green, blue-red, and blue-green lights are performed according to necessity. As shown in FIG. 2(c), the steps of calibration from S58 to S64 are the same as those for calibration of the R, G, and B lights with only the output light of the projector being changed to the red-green, blue-red, or blue-green light. After the required color calibrations are finished, those parts in the comparison table 16 having no comparison value are calculated by interpolation and then filled (Step S66).

The present invention can further perform the calibrations of other colors according to necessity. Moreover, the order of calibrations of the gray-scale lights, the R, G, and B lights, and the red-green, blue-red, and blue-green lights can be exchanged according to necessity.

To sum up, the present invention proposes a projector color calibration device and a method thereof, wherein a photo detection component is used to read the color brightness values of the R, G, and B lights at different environments for color calibration. A projector can thus automatically adjust the color brightness values of the output R, G, and B lights until an accurate projection color is obtained. The projector can match different environments to make the optimum automatic adjustment without the need of manual adjustment so as to obtain an accurate color output.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A projection color calibration device installed in a projector, said projector color calibration device comprising:
a photo detection component used to detect a color brightness value and convert said color brightness value into a proportional voltage value, said voltage value being converted into a digital signal by an analog-to-digital converter;
an image signal processing unit used to process an image signal inputted to said projector, said image signal being converted into a digital signal by another analog-to-digital converter, the processed image signal being stored into a memory; and
a central processor used to compare said color brightness value detected by said photo detection component with said image signal in said memory, to perform color calibration to adjust said image signal, and to store a comparison value of the color brightness value detected by said photo detection component with said calibrated image signal into a comparison table.

2. The projector color calibration device as claimed in claim 1, wherein said photo detection component is a photodiode, a charge coupled device, or a complementary metal oxide semiconductor.

3. A projector color calibration method for processing a color brightness value detected by a photo detection component and an output light of a projector, said projector color calibration method comprising the steps of:
(a) adjusting the output light of said projector to let read values of the red, green, and blue colors in said photo detection component are the smallest and the same, storing said read values into a comparison table, simultaneously storing output light values of said projector corresponding to said read values into said comparison table;
(b) adjusting the output light of said projector to let read values of the red, green, and blue colors in said photo detection component are the largest and the same, storing said read values into a comparison table, simultaneously storing output light values of said projector corresponding to said read values into said comparison table;
(c) setting several sets of values between the largest and smallest read values in said photo detection component and storing them into said comparison table, adjusting the output light of said projector so that said projector can satisfy said set values at different output light values, simultaneously storing different output light values of said projector corresponding to said set values into said comparison table; and
(d) calculating and then filling those parts in said comparison table having no comparison values by interpolation.

4. The projector color calibration method as claimed in claim 3, wherein colors displayed by said set values can be several sets of gray-scale colors, several sets of the red, green, and blue colors of different brightness, or several sets of colors arbitrarily mixed by the red, green, and blue colors.

5. The projector color calibration method as claimed in claim 3, wherein said photo detection component is a photodiode, a charge coupled device, or a complementary metal oxide semiconductor.

6. A projector color calibration method for processing a color brightness value detected by a photo detection component and an output light of a projector, said projector color calibration method comprising the steps of:
(a) adjusting the output light of said projector to let read values of the red, green, and blue colors in said photo detection component are the largest and the same, storing said read values into a comparison table, simultaneously storing output light values of said projector corresponding to said read values into said comparison table;
(b) adjusting the output light of said projector to let read values of the red, green, and blue colors in said photo detection component are the smallest and the same, storing said read values into a comparison table, simultaneously storing output light values of said projector corresponding to said read values into said comparison table;
(c) setting several sets of values between the largest and smallest read values in said photo detection component and storing them into said comparison table, adjusting the output light of said projector so that said projector can satisfy said set values at different output light values, simultaneously storing different output light values of said projector corresponding to said set values into said comparison table; and
(d) calculating and then filling those parts in said comparison table having no comparison values by interpolation.

7. The projector color calibration method as claimed in claim 6, wherein colors displayed by said set values can be several sets of gray-scale colors, several sets of the red, green, and blue colors of different brightness, or several sets of colors arbitrarily mixed by the red, green, and blue colors.

8. The projector color calibration method as claimed in claim 6, wherein said photo detection component is a photodiode, a charge coupled device, or a complementary metal oxide semiconductor.
